(19) United States
(12) Patent Application Publication
(10) Pub. No.: US 2001/0036763 A1
(43) Pub. Date: Nov. 1, 2001

(54) Mobile device, stationary device, and electrical connectors for them

(76) Inventor: Akira Funatsu, Tokyo (JP)

Correspondence Address: KANESAKA & TAKEUCHI, 1423 Powhatan Street, Alexandria, VA, 22314, US

(21) Appl. No.: 09/839,299

(22) Filed: Apr. 23, 2001

(30) Foreign Application Priority Data
Apr. 28, 2000 (JP) 2000-129347

(51) Int. Cl. H01R 4/50

(52) U.S. Cl. 439/341

(57) ABSTRACT

A plurality of terminals (15, 16) have contact sections (15A, 16A) projecting from the terminal support (19) of a connector housing (14) to abut against the terminal (34) of a mobile device (30). A pair of mount guiding columns (17) are provided on the connector housing (14) on opposite sides of the terminal support (19) so as to enter the mount recesses 38 of the mobile device (30). The mount guiding column (17) has such a shape and size as to allow the mobile device to rotate to an inclined position with the terminals (15, 16, 34) being in contact. A rotation guiding face (21A) is provided on the connector housing (14) for guiding the mobile device (30) to the inclined position.

### BACKGROUND OF THE INVENTION

1. Field of the Invention

The present invention relates to a mobile device, a stationary device for the mobile device, and electrical connectors for these devices.

2. Description of the Related Art

Japanese patent application Kohyo No. 10-511213 (JP'213) discloses a connector for bringing terminals of a mating device to regular positions for contact. A first connector has a guide pin, which is fitted in a slot of a second connector. The first and second connectors may be provided on a stationary device and a mobile device, respectively. By placing the mobile device on the stationary device to make an electrical connection between them, power charging and signal exchange are made through the power and signal terminals, respectively.

Japanese patent application Kokai No. 8-17503 (JP'503) discloses a mobile device that is mounted obliquely on the stationary device. As FIG. 9 shows, a mobile device or phone 60 is mounted on a stationary device or battery charger 50 for charging. The battery charger 50 comprises a housing 51 that has an inclined support recess 52 into which the mobile phone 60 is placed. A connector 53 is provided on the bottom of the support recess 52 and has a pin terminal 53A that is movable in an up-and-down direction. A flat terminal 61 is provided on the bottom of the mobile phone 60 so that when the mobile phone 60 is mounted in the support recess 52, the terminals 53A and 61 are brought into contact with each other for electrical connection. The contact point between the terminals 53A and 61 moves around during the electrical connection, producing the so-called “wiping effect”.

The above connectors 53 and 61, however, have the following disadvantages.

In JP'213, both the devices are connected in a fixed posture so that no wiping effect is obtained.

In JP'503 or FIG. 9, the movement of the contact point is caused by the inclination of the mobile phone 60 and is not extensive. In addition, there is no guide pin, failing to not only keep an accurate position but also meet the needs for a connector having a large number of signal terminals that are arranged densely.

### SUMMARY OF THE INVENTION

Accordingly, it is an object of the invention to provide a mobile device, a stationary device, and a connector for them capable of providing accurate positioning and the wiping effect produced during the entire period between the start and the end of rotation of the mobile device.

The invention relates a stationary device, a mobile device, and electrical connectors for making electrical connection between the mobile and stationary devices when the mobile device is mounted on said stationary device.

According to an aspect of the invention there is provided an electrical connector which comprises a connector housing having a terminal support; a plurality of terminals having contact sections projecting from said terminal support; a pair of mount guiding columns provided on said connector housing and has such a shape and size as to allow said mobile device to rotate to an inclined position; and a rotation guiding face for guiding said mobile device to rotate to said inclined position.

Since the mount guiding columns determine the positions of the mobile device at the start and end of mounting operation and the rotation guiding face guides the rotation of the mobile device, the wiping effect between the terminals is assured.

The electrical connector for the mobile device has a bearing recess with a bearing face for engagement with the rotation guiding face of the stationary device. The stationary device further comprises a receiving member for support the mobile device at the inclined position. The receiving member and the rotation guiding member may be provided on the device case or a member provided on the device case as well as the connector housing along with the mount guiding columns.

The connector housing may be integrated with said device case as a unit. The mount guiding columns are provided on opposite sides of said terminal support or provided on opposite sides of said terminal support in a direction that said terminals are arranged. The mount guiding columns are inclined toward said inclined position. The mobile device has a bearing recess with a bearing face for engagement with the rotation guiding member. The bearing face has a curved face that matches a curved face of said rotation guiding member or a V-shaped section.

### BRIEF DESCRIPTION OF THE DRAWINGS

FIG. 1 is a perspective view of parts of a mobile device and a stationary device according to an embodiment of the invention;

FIG. 2 is a sectional view of the mobile device prior to mount on the stationary device;

FIG. 3 is a sectional view of rotation guiding and bearing faces for the stationary and mobile devices, respectively;

FIG. 4 is a sectional view of the mobile device being mounted on the stationary device;

FIG. 5 is a sectional view of the mobile device having been mounted on the stationary device;

FIG. 6 is a sectional view of connectors for mobile and stationary devices, respectively, according to another embodiment of the invention;

FIG. 7 is a sectional view of connectors according to a modification to the embodiment of FIG. 6;

FIG. 8 is a sectional view of connectors according to another modification to the embodiment of FIG. 6; and

FIG. 9 is a sectional view of conventional mobile and stationary devices.

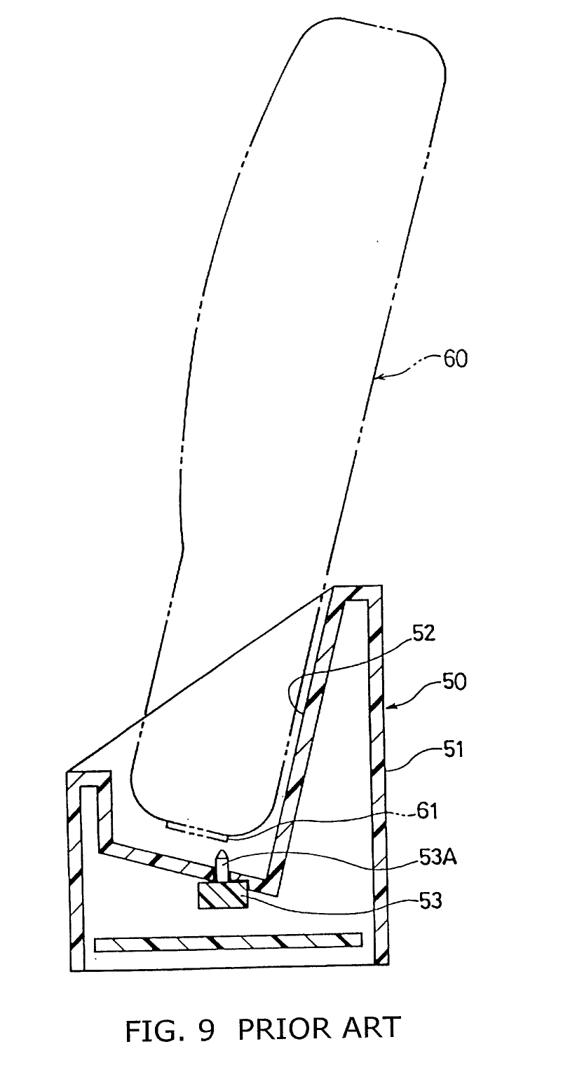

### DESCRIPTION OF THE PREFERRED EMBODIMENT

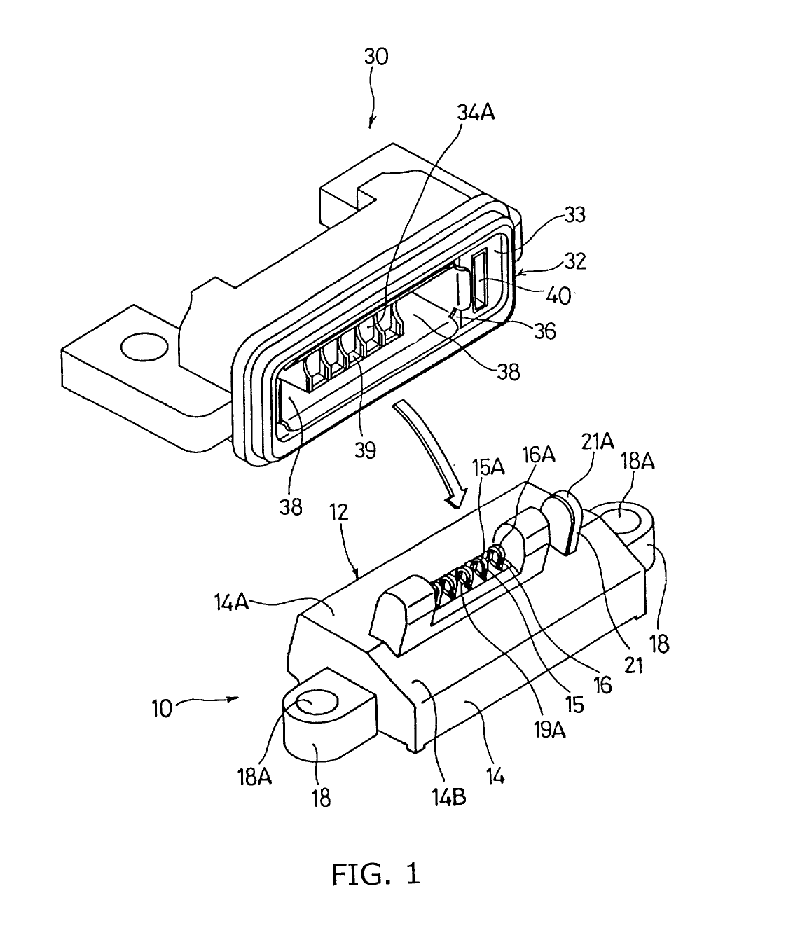

Embodiments of the invention will now be described with reference to the accompanying drawings, FIGS. 1-8.

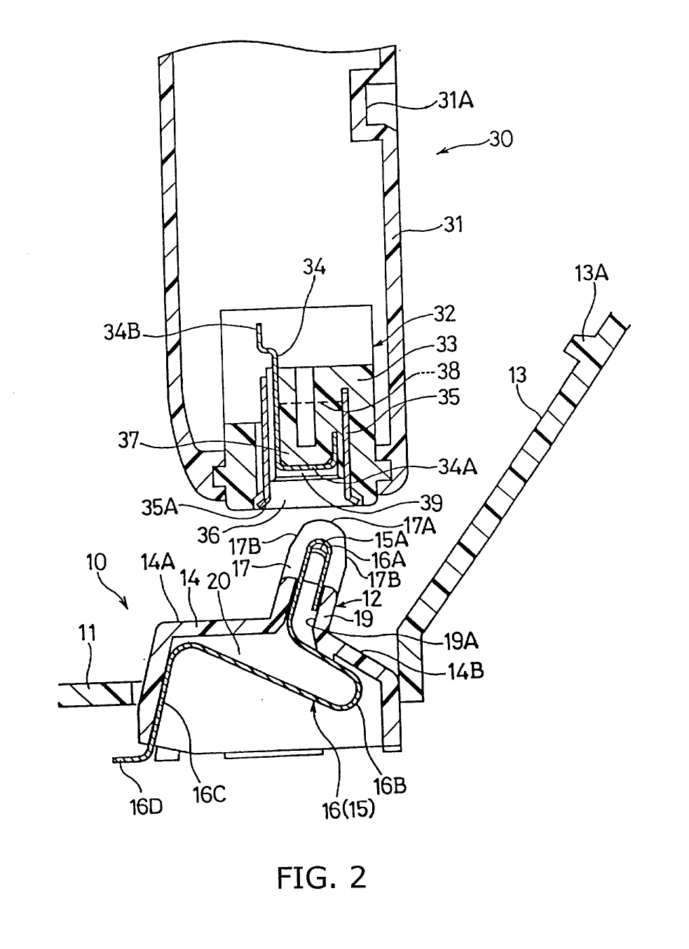

In FIGS. 1 and 2, a stationary device 10 comprises a case 11 that has an upper opening in which a connector 12 provided and a receiving section 13 that extends obliquely from the side of the upper opening and has an engaging projection 13A.

As best shown in FIG. 1, the connector 12 comprises a housing 14 of an insulative material and a plurality of terminals 15 and 16 arranged in the housing 14. The housing 14 has a horizontal face 14A and an inclined face 14B that extends obliquely downwardly from the horizontal face 14A. A pair of mount guiding columns 17 extend obliquely upwardly from the edge between the horizontal and inclined faces 14A and 14B and flank the contact sections 15A and 16A of the terminals 15 and 16. A pair of leg sections 18 extend laterally from opposite sides of the housing 14 and have fixing apertures 18A into which screws are inserted to secure the connector 12 to the stationary device 10.

A terminal support 19 extend upwardly to a half of the height of the mount guiding columns 17 and has a plurality of support slots 19A that support the terminals 15 and 16 and communicate with respective internal spaces 20 of the housing 14. The slots 19A and the internal spaces 20 extend in respective planes parallel to the picture plane of FIG. 2.

The contact section 16A of a power terminal 16 extends upwardly from the terminal support 19 more than the contact section 15A of a signal terminal 15. The power terminals 16 on opposite ends of the terminal row and the signal terminals 15 between them are used to transmit power terminals and signal terminals, respectively. Both the terminals 15 and 16 are identical except for the height of the contact sections 15A and 16A and, therefore, only the power terminal 16 will be described.

In FIG. 2, the power terminal 16 has, from above, a contact section 16A, a flexible section 16B, a fixing section 16C, and a connection section 16D. The contact section 16A has an inverted U-shape that projects from the support slot 19A. The flexible section 16B extends obliquely downwardly from the contact section 16A and then obliquely upwardly to form a U-shaped curve in the internal space 20 so that it is flexed when the contact section 16A is pressed downwardly. The fixing section 16C is brought into close contact with and supported by the inner face of the housing 14. The connection section 16D extends horizontally through the housing 14 and is connected to a corresponding trace of a circuit board provided in the stationary device 10. The mount guiding column 17 has a circular top face 17A and a pair of inclined side faces 17B. Best shown in FIG. 2, the contact sections 15A and 16A are located within the outline of the guiding columns 17.

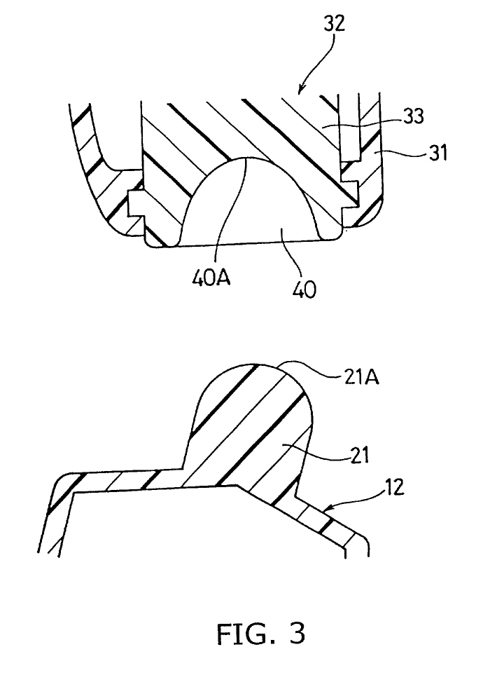

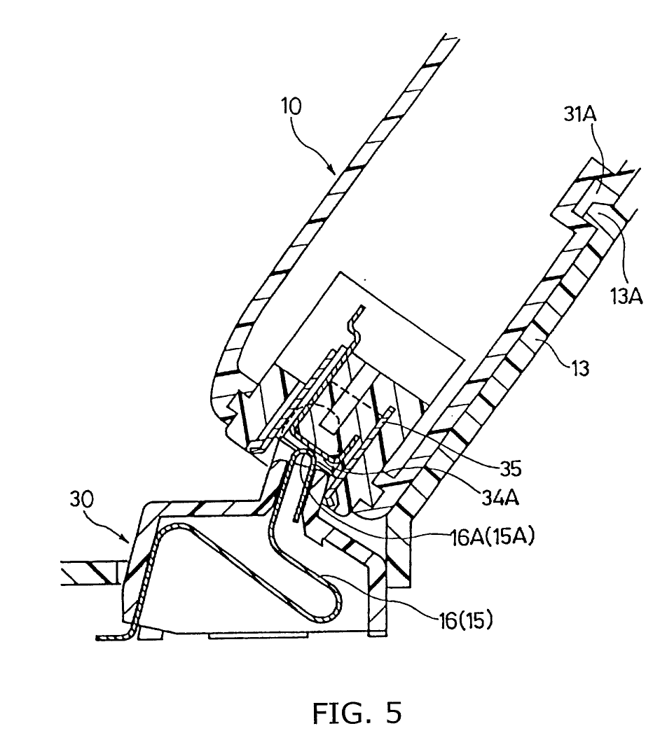

A rotation guiding column 21 is provided adjacent to one of the mount guiding columns 17. The rotation guiding column 21 is lower than the mount guiding columns 17 and has a circular top or rotation guiding face 21A. (Also see FIG. 3.) The mobile device 30, such as mobile telephone, comprises a case 31 and a connector 32 provided on the bottom of the case 31, in which a circuit member (not shown) is accommodated. An engaging recess 31A is provided in a side of the case 31 for engagement with the engaging projection 13A to support the mobile device 30 in an oblique posture (FIG. 5).

The connector 32 comprises a housing block 33 of an insulative material, a plurality of terminals 34 provided in the housing block 33, and a shield tube 35 provided around the terminals 34. A receiving cavity 36 is provided in the housing 33 for accommodating the mount guiding columns 17 of the mating connector 12. A terminal island 37 is provided in the receiving cavity 36. A pair of mount recesses 38 are provided in the receiving cavity 36 on opposite sides of the terminal island 37.

A plurality of indentations 39 are provided in the terminal island 37 at positions corresponding to the terminals 15 and 16 of the stationary device 10 for accommodating the contact sections 34A of terminals 34. The contact section 34A is provided at one end of the terminal 34 and has a flat section on the bottom of the indentation 39. The contact sections 34A of a plurality of terminals 34 are at the same level so that the power terminals 16 of the stationary device 10 make contact with the terminals 34 of the mobile device 30 prior to the signal terminals 15. The terminal 34 has at the other end a connection section 34B that is connected to a corresponding circuit (not shown) of the mobile device 30.

The shield plate or tube 35 extend along the inside wall of the receiving cavity 36 such that the open edge 35A is located at the open edge of the receiving cavity 36. A bearing recess 40 is provided in the housing 33 outside the shield tube 35 for accommodating the rotation guiding column 21 of the stationary device 10. It has at the bottom a circular bearing face 40A that matches the rotation guiding face 21A of the guiding column 21 for sliding movement along with rotation of the mobile device 30 to the inclined position. On the other hand, the mount guiding columns 17 and the mount recesses 38 are not in contact; i.e., there is a gap between them.

The operation of the devices will be described below.

(1) When the mobile device 30 is charged or exchanges signals with the stationary device 10, the mobile device 30 is brought to a position above the stationary device 10 such that the mount recess 38 faces the mount guiding column 17 of the stationary device 10 as shown in FIG. 2.

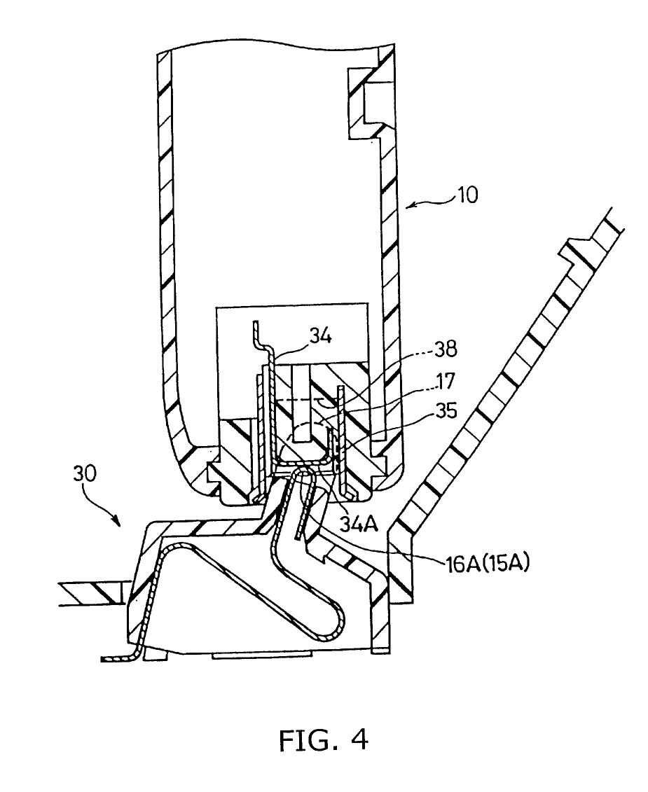

(2) Then, the mobile device 30 is moved downwardly so that the mount guiding column 17 enters the mount recess 38, bringing the respective terminals to predetermined positions as shown in FIG. 4. Since the contact sections 15A and 16A of signal and power terminals 15 and 16 are situated within the outline of the mount guiding column 17 and the contact section 16A of the power terminals 16 extend more than the contact section 15A of the signal terminals 15, first the power terminal 16 and then the signal terminals 15 make contact with the contact sections 34A of mating terminals 34 without contact with the shield case 35 of the mobile device 30.

(3) When the terminals begin to make contact, the bearing face 40A of the mobile device 30 makes contact with the rotation guiding face 21A of the stationary device 10.

(4) Then, the mobile device 30 is rotated to the receiving section 13 of the stationary device 10 with the rotation guiding face 21A sliding on the bearing face 40A. When the mobile device 30 is rotated to a predetermined position, the engaging recess 30A of the mobile device 30 engages the engaging projection 13A of the receiving section 13 to lock the posture (FIG. 5). The contact points between the contact sections 15A and 16A of the stationary device 10 and the contact sections 34A of the mobile device 30 move along with the rotation of the mobile device 30. Since the guiding column 17 is inclined toward the receiving section 13 and has the inclined side faces 17, it is possible to provide a large angle of rotation, producing the strong wiping effect between the contact sections 15A and 16A, and 34A. The terminals 15 and 16 of the stationary device 10 are flexed at the flexible sections by the weight of the mobile device 30 so that the contact sections 15A and 16A are moved resiliently downwardly in the housing 14 and wiped by the contact sections 34 of the mobile device 30 under the resilient force.

(5) Thus, every time the mobile device 30 is mounted on the stationary device 10, the wiping effect of the terminals are obtained to optimize the charging and signal exchange operations through the power and signal terminals, respectively.

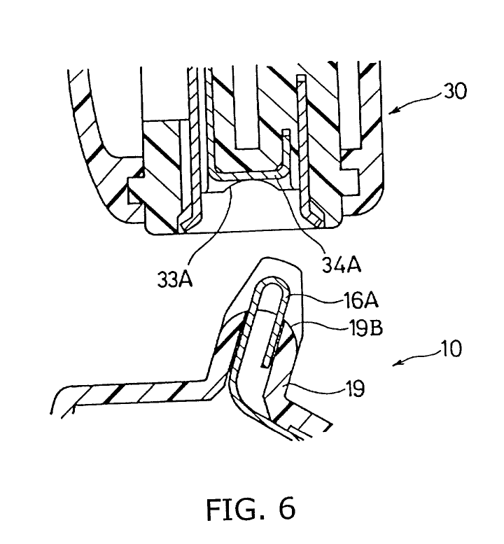

Another embodiment of the invention will be described below with reference to FIG. 6, which corresponds to FIG. 2 and like components are assigned with the same reference numerals and their description is omitted.

A rotation guiding section 19B is provided on the terminal support 19. More specifically, the terminal support 19 has circular top faces between adjacent contact sections 15A and 16A. A circular bearing face 33A is provided on the housing 33 of the connector 32 at a position corresponding to the rotation guiding face 19B. By providing the rotation guiding face 19B and the bearing face 33A in the region of the connector, it is possible to provide a compact connector capable of making smooth sliding movement with the use of no rotation guiding column 21.

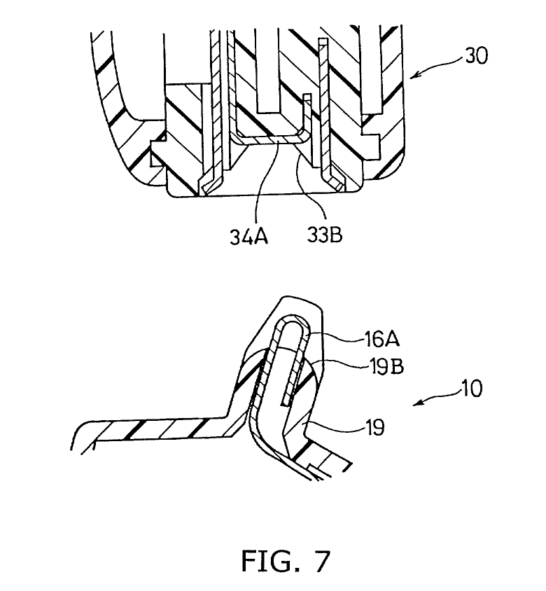

In FIG. 7, a modification to the embodiment of FIG. 6 is shown. The circular bearing face 33A of FIG. 6 is replaced by a V-shaped bearing face 33B.

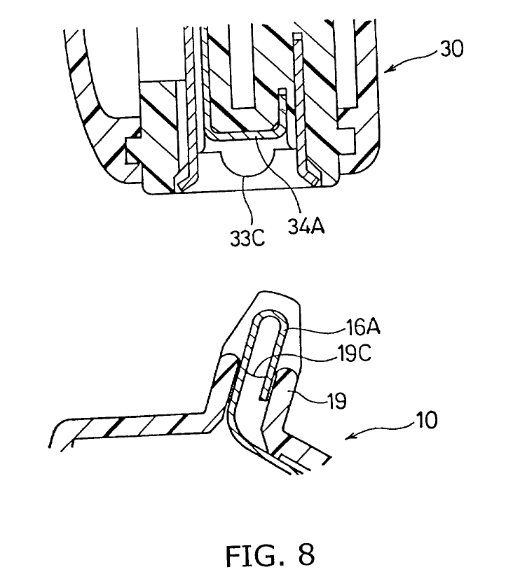

In FIG. 8, the rotation guiding face 19C and the bearing face 33C are concave and convex, respectively, in contrast to those of FIG. 6.

Alternately, the rotation guiding face may be provided on the mount guiding column by making its top a concave or convex face while the bearing face of a mobile device is made to match the configuration.

A variety of modifications may be made to the illustrated embodiments. For example, the outline of the mount guiding column may be made of a continuously curved line or a plurality of broken lines joined together. At any rate, it is desired that the mounting and rotation of the mobile device on the stationary device be made smooth and the mounting posture be stable. The housing of a connector for each of the devices, especially stationary device, may be integrated with the device case. The receiving section may be integrated with a side wall of the mount guiding column, which is made tall for stabilizing the stationary device. The mount guiding column may stand upright.

As has been described above, according to the invention, the mount guiding column enables not only guide but also rotate the mobile device along the rotation guiding face so that it is possible to not only provide easy and accurate positioning by the mount guiding column but also smooth rotation by the rotation guiding face to provide the wiping effect, resulting in the clean contact sections of terminals.

1. A stationary device for receiving a mobile device therein for electrical connection, said stationary device comprising:
a stationary case;
a stationary connector supported by said stationary case, said stationary connector including:
a connector housing having a terminal support;
a plurality of terminals having contact sections projecting from said terminal support;
a pair of mount guiding columns provided on said connector housing and has such a shape and size as to allow said mobile device to rotate to an inclined position;
a receiving member extending from said stationary case for supporting said mobile device at said inclined position; and
rotation guiding means for guiding said mobile device for rotation to said inclined position.

2. The stationary device according to claim 1, wherein said connector housing is integrated with said stationary case as a unit.

3. The stationary device according to claim 1, wherein said mount guiding columns are provided on opposite sides of said terminal support.

4. The stationary device according to claim 1, wherein said mount guiding columns are provided on opposite sides of said terminal support in a direction that said terminals are arranged.

5. The stationary device according to claim 1, wherein said rotation guiding means has a circular top face.

6. The stationary device according to claim 5, wherein said circular top face is either convex or concave.

7. The stationary device according to claim 1, wherein said mount guiding columns are inclined toward said inclined position.

8. A stationary connector for a stationary device that receives a mobile device therein for electrical connection, said stationary connector comprising:
a connector housing having a terminal support;
a plurality of terminals having a contact section projecting from said terminal support;
a pair of mount guiding columns provided on opposite sides of said terminal support and having such a shape and size as to allow said mobile device to rotate to an inclined position; and
rotation guiding means provided on said connector housing for guiding said mobile device to said inclined position.

9. The mobile device according to claim 1, which further comprises a bearing face for engagement with said rotation guiding means of said stationary device.

10. The mobile device according to claim 9, wherein said bearing face has a curved face that matches a curved face of said rotation guiding means.

11. The mobile device according to claim 9, wherein said bearing face has a V-shaped section.

12. A mobile connector for said mobile device for connection with said stationary connector according to claim 8, said mobile connector has a bearing recess with a bearing face for engagement with said rotation guiding means.
